(19) United States
(12) Patent Application Publication
(10) Pub. No.: US 2025/0060772 A1
(43) Pub. Date: Feb. 20, 2025

(54) CONTROL KNOB

(71) Applicant: HARMAN INTERNATIONAL INDUSTRIES, INCORPORATED, Stamford, CT (US)

(72) Inventors: Matthew Colin MANTLE, Thretford (GB); Paul NEVILLE, Winchester (GB)

(73) Assignee: HARMAN INTERNATIONAL INDUSTRIES, INCORPORATED, Stamford, CT (US)

(21) Appl. No.: 18/807,528

(22) Filed: Aug. 16, 2024

(30) Foreign Application Priority Data
Aug. 18, 2023 (EP) 23 192 167.7

(51) Int. Cl. G05G 1/10; G05G 1/02

(52) U.S. Cl. CPC G05G 1/10; G05G 1/02

(57) ABSTRACT

A control knob comprises an encoder assembly configured to convert rotary and axial input movement into electronic signals, and a knob assembly attached to the encoder assembly and configured to be operated by a user, wherein the encoder assembly comprises a shaft encoder having a shaft that is configured to be rotated around a rotation axis and to be moved axially along the rotation axis, the knob assembly comprises an outer knob element configured to be operated by a user, the knob assembly further comprises a bush defining a cylindrical cavity inside the outer knob element, wherein the bush has an opening towards a first side of the outer knob element facing towards the encoder assembly, the knob assembly further comprises a driver element extending into the bush from a second side opposite the first side.

### CROSS-REFERENCE TO RELATED APPLICATIONS

This application claims priority to EP Application Serial No. 23192167.7 filed Aug. 18, 2023, the disclosure of which is hereby incorporated in its entirety by reference herein.

### TECHNICAL FIELD

The disclosure relates to a control knob, in particular to a control knob that allows rotary motion as well as linear motion.

### BACKGROUND

Control knobs are used for many different applications. In media devices, for example, control knobs may be used for regulating or adjusting different parameters such as, e.g., a volume of sound that is output by the media device. Generally speaking, a control knob is a rotary device that can be used to provide manual input adjustments to a mechanical or electrical system when grasped and turned by a human operator. Differing extend of knob rotation usually corresponds to different desired input. Control knobs are a simple type of input hardware and are very common in different kinds of control systems. Common control knobs work by turning a shaft which connects to a component (e.g., encoder) which produces the actual input.

There is a need for a control knob which, in addition to rotary motion, is able to allow linear motion, which has a high-quality feel and may be operated smoothly with minimal play, maximum rigidity for its support, and with high precision, and which may be manufactured at low cost.

### SUMMARY

A control knob includes an encoder assembly configured to convert rotary and axial input movement into electronic signals, and a knob assembly attached to the encoder assembly and configured to be operated by a user, wherein the encoder assembly includes a shaft encoder having a shaft that is configured to be rotated around a rotation axis and to be moved axially along the rotation axis, the knob assembly comprises an outer knob element configured to be operated by a user, the knob assembly further includes a bush defining a cylindrical cavity inside the outer knob element, wherein the bush has an opening towards a first side of the outer knob element facing towards the encoder assembly, the knob assembly further includes a driver element extending into the bush from a second side opposite the first side, and enclosing the shaft of the shaft encoder to transfer a movement of the outer knob element to the shaft encoder, the encoder assembly further comprises a bearing collar, the bearing collar defining an inner volume that is open towards a first side and towards a second side opposite the first side, wherein the shaft encoder from the first side extends into the inner volume of the bearing collar towards the second side, the driver element extends into the inner volume of the bearing collar from the second side towards the first side, and between the shaft of the shaft encoder and the bearing collar.

Other systems, features and advantages of the disclosure will be or will become apparent to one with skill in the art upon examination of the following detailed description and figures. It is intended that all such additional systems, methods, features and advantages included within this description, be within the scope of the invention and be protected by the following claims.

### BRIEF DESCRIPTION OF THE DRAWINGS

The arrangements may be better understood with reference to the following description and drawings. The components in the figures are not necessarily to scale, emphasis instead being placed upon illustrating the principles of the invention. Moreover, in the figures, like referenced numerals designate corresponding parts throughout the different views.

FIG. 1 schematically illustrates a cross-sectional view of a control knob comprising an encoder assembly and a knob assembly.

FIG. 2 schematically illustrates an exploded view of a encoder assembly of a control knob according to embodiments of the disclosure.

FIG. 3 schematically illustrates a three-dimensional view of the encoder assembly of FIG. 2 in its assembled state.

FIG. 4 schematically illustrates a front view of the encoder assembly of FIG. 2 in its assembled state.

FIG. 5 schematically illustrates a cross-sectional view of the encoder assembly of FIG. 2.

FIG. 6 schematically illustrates an exploded view of a knob assembly of a control knob according to embodiments of the disclosure.

FIG. 7 schematically illustrates a three-dimensional view and a cross-sectional view of a bush of the knob assembly of FIG. 6.

FIG. 8 schematically illustrates a three-dimensional view of the knob assembly of FIG. 6 in its assembled state.

FIG. 9 schematically illustrates a back view of the knob assembly of FIG. 6 in its assembled state.

FIG. 10 schematically illustrates a cross-sectional view of the knob assembly of FIG. 6.

FIG. 11 schematically illustrates an exploded three-dimensional view of a knob assembly of a control knob according to further embodiments of the disclosure.

FIG. 12 schematically illustrates an exploded cross-sectional view of a control knob according to further embodiments of the disclosure.

FIG. 13 schematically illustrates a three-dimensional exploded cross-sectional view of the control knob of FIG. 12.

FIG. 14 schematically illustrates an exploded three-dimensional view of a control knob according to further embodiments of the disclosure.

FIG. 15 schematically illustrates the exploded three-dimensional view of the control knob of FIG. 14 from a different perspective.

FIG. 16 schematically illustrates the control knob of FIG. 14 in a partly assembled state.

FIG. 17 schematically illustrates the control knob of FIG. 15 in a partly assembled state.

FIG. 18 schematically illustrates an axial movement of the knob assembly.

FIG. 19, including FIGS. 19A and 19B, schematically illustrates a side view (FIG. 19A) and a front view (FIG. 19B) of a control knob according to embodiments of the disclosure in its assembled state.

### DETAILED DESCRIPTION

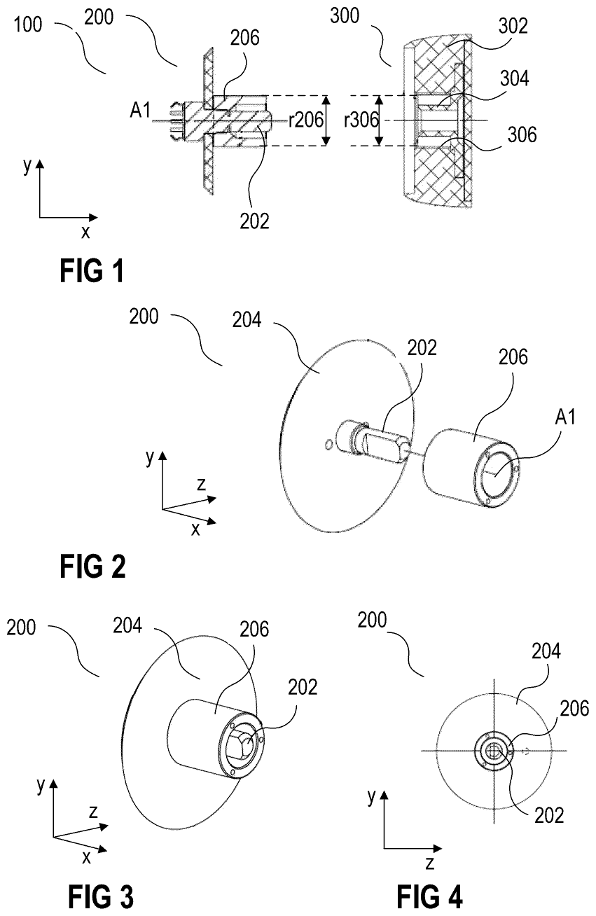

FIG. 1 schematically illustrates a cross-sectional view of a control knob 100 according to embodiments of the disclosure. The control knob 100 comprises an encoder assembly 200 configured to convert rotary and axial input movement into electronic signals, and a knob assembly 300 attached to the encoder assembly 200 and configured to be operated by a user. The knob assembly 300 generally is the visible part of the control knob 100 and covers the encoder assembly 200. The encoder assembly 200 comprises a shaft encoder 202 configured to be rotated around a rotation axis A1 and to be moved axially along the rotation axis A1. Shaft encoders 202 are generally known and are often also referred to as rotary encoders. A shaft encoder 202 is a device that is able to detect a rotational angle of its shaft, for example, with respect to a base element. Shaft encoders are often used for control knobs. Generally absolute shaft encoders as well as incremental encoders are known. While absolute shaft encoders can determine a current position of its shaft from the moment the shaft encoder is powered up, incremental encoders can immediately detect changes in position, but are generally not able to track absolute shaft positions.

In one example, an absolute shaft encoder may use mechanical, magnetic or optical sensors with a rotating disc to determine the shaft position. Mechanical encoders use sliding contacts and a disc with metal patterns designed to encode the shaft position. Magnetic encoders sense the position of magnetized strips on a disc while optical disc encoders read specially-coded light and dark areas. An absolute shaft encoder outputs position data in either digital or analog form, usually depending upon the configuration of the device. For example, digital data may be represented in binary, gray code, or binary coded decimal. Incremental shaft encoders, often also known as quadrature encoders, measure relative shaft movement. This type of shaft encoder usually uses only two optical or mechanical sensors from one angle to the next. In order to keep track of the current position of the shaft, external circuitry can be used to count shaft movements from a reference point. In mechanical encoders, for example, cams on the shaft make contact with mechanical sensors to indicate the shaft position. Optical encoders can determine movement by reading light and dark coded tracks, for example, via photodiodes. The shaft encoder 202 included in the control knob 100 as described herein can be implemented in any suitable way and is not restricted to any specific implementation.

The knob assembly 300 comprises an outer knob element 302 configured to be operated by a user. The knob assembly 300 generally is the part which is contacted by a user's hand. The knob assembly 300 further comprises a bush 306 defining a cylindrical cavity inside the outer knob element 302, wherein the bush 306 has an opening towards a first side of the outer knob element 302 facing towards the encoder assembly 200. The first side of the outer knob element 302 is generally not visible for a user, as it faces towards the encoder assembly 200. The knob assembly 300 further comprises a driver element 304 extending into the bush 306 from a second side of the bush 306 opposite the first side. The driver element 304, when the control knob is fully assembled, encloses a shaft of the shaft encoder 202 to transfer a movement of the outer knob element 302 to the shaft encoder 202. The shaft of the shaft encoder 202 generally is comparably small and the shaft itself may be inconvenient for a user to rotate without the knob assembly 300. The knob assembly 300 provides a convenient interface for the user, as the outer knob element 302 generally is significantly larger as compared to the shaft of the shaft encoder 202. Even further, the outer knob element 302 is more aesthetically pleasing than the shaft encoder 202. The bush 306 and the driver element 304 are securely attached to the outer knob element 302 in any suitable manner such that the bush 306 and the driver element 304 rotate together with the outer knob element 302. As the driver element 304 tightly encloses the shaft of the shaft encoder 202, the movement of the outer knob element 302 is reliably transferred to the shaft encoder 202.

Still referring to FIG. 1, the encoder assembly 200 further comprises a bearing collar 206, the bearing collar 206 defines an inner volume that is open towards a first side and towards a second side opposite the first side. The second side of the bearing collar 206 facing towards the knob assembly 300. The shaft encoder 202 from the first side extends into the inner volume of the bearing collar 206 towards the second side. The driver element 304 extends into the inner volume of the bearing collar 206 from the second side towards the first side, and between the shaft of the shaft encoder 202 and the bearing collar 206. That is, when the control knob 100 is fully assembled, the bearing collar 206 extends around at least a part of the shaft encoder 202 as well as around at least a part of the driver element 304.

FIG. 1 schematically illustrates a partly assembled control knob 100. In particular, the encoder assembly 200 is fully assembled, with the bearing collar 206 arranged to surround at least the shaft of the shaft encoder 202, and the knob assembly 300 is fully assembled, with the driver element 304 extending into the bush 306. The knob assembly 300 and the encoder assembly 200, however, have not yet been put together in the cross-sectional view of FIG. 1. When the encoder assembly 200 and the knob assembly 300 have been assembled with one another and the outer knob element 302 is rotated by a user, the driver element 304 which is firmly attached to the shaft encoder 202 transfers the movement of the outer knob element 302 to the shaft encoder 202.

The bush 306 may have a smooth inner surface facing towards the cylindrical cavity, and the bearing collar 206 may have a smooth outer surface facing away from the shaft encoder 202 arranged inside the inner volume defined by the bearing collar 206. As is schematically illustrated in FIG. 1, an inner diameter r306 of the bush 306 may correspond to or may be marginally larger than an outer diameter r206 of the bearing collar 306. For example, the inner diameter r306 of the bush 306 may be up to 0.1 mm, up to 0.25 mm, or up to 0.5 mm (millimeters) larger than the outer diameter r206 of the bearing collar 206. In this way, when the outer knob element 302 is operated by a user, the inner surface of the bush 306 smoothly glides along the outer surface of the bearing collar 206. That is, the bearing collar 206 provides a smooth surface for the bush 306 to run on. This improves the handling of the control knob 100. The control knob 100 as illustrated in FIG. 1 is accurate, as the movement of the outer knob element 302 is directly transferred to the shaft encoder 202 by the driver element 304. On the other hand, the knob assembly 300 may be smoothly operated by a user and provides a highly increased user experience. On the other hand, the effects as mentioned above may be achieved by comparably inexpensive elements, resulting in a very low-cost, high precision control knob arrangement. Any unintentional wobbling of the knob assembly 300 during its use is avoided by the bush 306 gliding along the surface of the bearing collar 206, as the knob assembly 300 is always maintained concentric with respect to the shaft encoder 202.

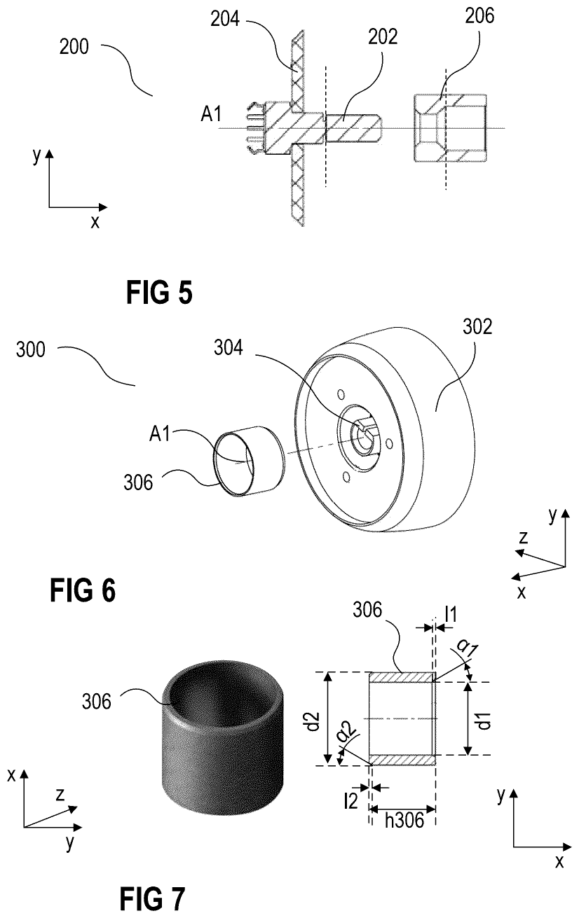

The encoder assembly 200 is illustrated in further detail in FIGS. 2-5. FIG. 2 schematically illustrates a partly exploded view of an encoder assembly of a control knob 100 according to embodiments of the disclosure. FIG. 3 schematically illustrates a three-dimensional view of the encoder assembly 200 of FIG. 2 in its assembled state. FIG. 4 schematically illustrates a front view of the encoder assembly 200 of FIG. 2 in its assembled state. FIG. 5 schematically illustrates a cross-sectional view of the encoder assembly 200 of FIG. 2. From these Figures, the arrangement of the bearing collar 206 with respect to the shaft encoder 202 is clearly visible. The outer periphery of the bearing collar 206 is cylindrical, similar to the inner surface of the bush 306, in order to provide a surface for the bush 306 to run on. The internal volume defined by the bearing collar 206 may be at least partly cylindrical. For example, a first section of the bearing collar 206 which surrounds the shaft of the shaft encoder 202 which is contacted by the driver element 304 (driver element 304 not illustrated in FIGS. 2-5) may be cylindrical. An inner diameter or radius of this first section may be larger than an outer diameter or radius of the shaft of the shaft encoder 202, and larger than an outer diameter or radius of the driver element 304. In this way, there is sufficient space between the shaft and the bearing collar 206 to allow the driver element 304 to firmly engage with the shaft.

A second section of the bearing collar 206 may define an inner volume that is not cylindrical. The first section and the second section of the inner volume as defined by the bearing collar are separated by a dashed line in FIG. 5. A shape of the inner volume defined by the second section may at least partly correspond to a shape of the shaft encoder 202 (e.g., a shape of the base element). In this way, the bearing collar 206 may be securely attached to the shaft encoder 202, while still allowing the driver element 304 to engage with the shaft. The bearing collar 206 may be attached to the base element of the shaft encoder 202 such that the bearing collar 206 also remains stationary when the outer knob element 302 is rotated. For example, the second section of the bearing collar 206 may comprise a thread, and the base element of the shaft encoder 202 may comprise a counter thread such that the bearing collar 206 may be screwed onto the shaft encoder 202. Instead of or in addition to the shaft encoder 202, the bearing collar 202 may also be attached to a fascia panel 204. A fascia panel 204 is optional and will be described in further detail below. The shape of the inner volume of the bearing collar 206 is generally of lower importance, as the bearing collar is mainly configured to provide a surface and rigid fixture for the bush 306 to run on.

The shaft encoder 202 may be coupled to a plate or fascia panel 204, as is schematically illustrated in FIGS. 2-5. The shaft encoder 202 comprises the shaft and may further comprise a base element, wherein the shaft of the shaft encoder 202 is movable with respect to the base element. The fascia panel 204 may have a first main surface and a second main surface opposite the first main surface, and a hole extending through the fascia panel 204 from the first to the second main surface. The shaft encoder 202 may extend through the hole in the fascia panel 204 such that the base element is at least partly arranged on a first side of the fascia panel 204, and the shaft of the shaft element 202 is arranged on a second side of the fascia panel 204. That is, the fascia panel 204 can be considered carrying the shaft encoder 202. As is schematically illustrated in FIG. 5, for example, the base element may partly extend through the hole in the fascia panel 204. An interface between the base element and the shaft is indicated by a dashed line as illustrated in FIG. 5. When the shaft of the shaft encoder 202 is rotated, the fascia panel 204 does not rotate together with the shaft but remains stationary, just as the base element remains stationary. In the figures, the fascia panel 204 has a circular shape. This, however, is only an example. The fascia panel 204 may have any other suitable shape instead.

Now referring to FIGS. 6 to 11, a knob assembly 300 according to embodiments of the disclosure will be described in further detail. FIG. 6 schematically illustrates a partly exploded view of a knob assembly 300 of a control knob 100 according to embodiments of the disclosure. The knob assembly 300 is illustrated as seen from a back side in FIG. 6, that is, from a side which faces towards the encoder assembly 200. In FIG. 6, the outer knob element 302 is visible as well as the driver element 304 arranged inside a volume defined by the outer knob element 302. The bush 306 in this view has not yet been inserted into the outer knob element 302. As can be seen and as is illustrated in further detail in FIG. 7, the bush 306 may be a basic component having an inner diameter d1 and an outer diameter d2. The inner volume defined by the bush 306 is cylindrical in order to be able to smoothly run along the outer surface of the bearing collar 206 which is also cylindrical.

A lip of the bush 306 towards it first side as well as towards its second side may be rounded or angled. That is, sharp edges (α1=0°, α2=) 0° between the internal surface and the lateral surfaces facing towards the first end and the second end, and between the external surface and the lateral surfaces may be avoided, for example, to aid assembly.

In one example, the bush 306 may be retained in the outer knob element 302 by a precision interference fit. An interference fit, often also referred to as pressed fit or friction fit, generally is a form of fastening between two tightfitting mating parts that produces a joint which is held together by friction after the respective parts have been pushed together. Alternatively, the bush 306, however, may be attached to the outer knob element 302 in any other suitable way, or may even be integrally formed with the outer knob element 302. The bush 306 provides an interface between the movable outer knob element 302 and the fixed encoder assembly 200.

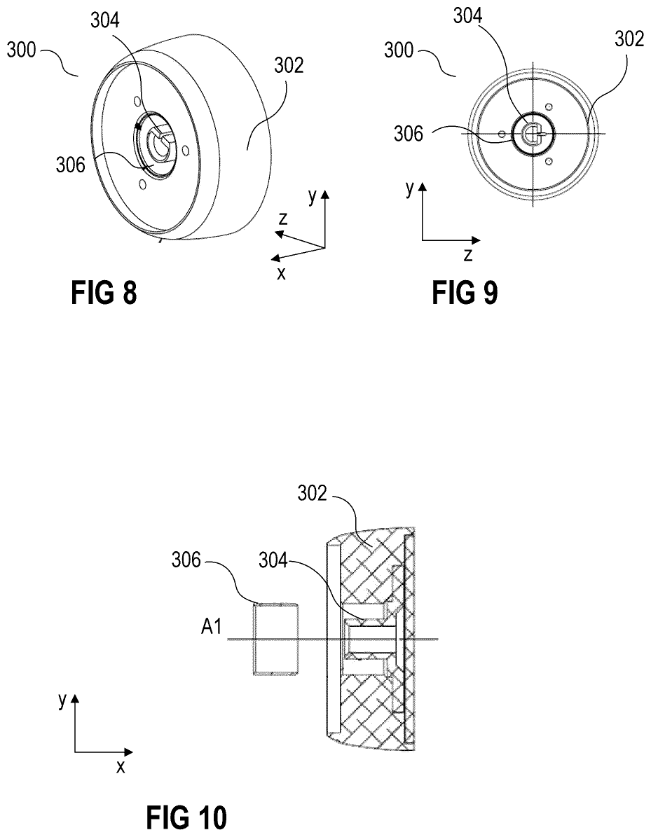

FIG. 8 schematically illustrates a three-dimensional view of the knob assembly of FIG. 6 in an assembled state. FIG. 9 schematically illustrates a back view of the knob assembly of FIG. 6 in an assembled state. The knob assembly 300 as illustrated in FIGS. 8 and 9, for example, is ready to be pushed onto the encoder assembly 200 as illustrated in FIGS. 3 and 4. FIGS. 8 and 9 illustrate the knob assembly 300 from a back side, that is from a side which, in the fully assembled state, faces towards the encoder assembly 200 and is therefore generally not visible for a user. FIG. 10 schematically illustrates a cross-sectional view of the knob assembly of FIG. 6, wherein the bush 306 has not yet been mated with the outer knob element 302.

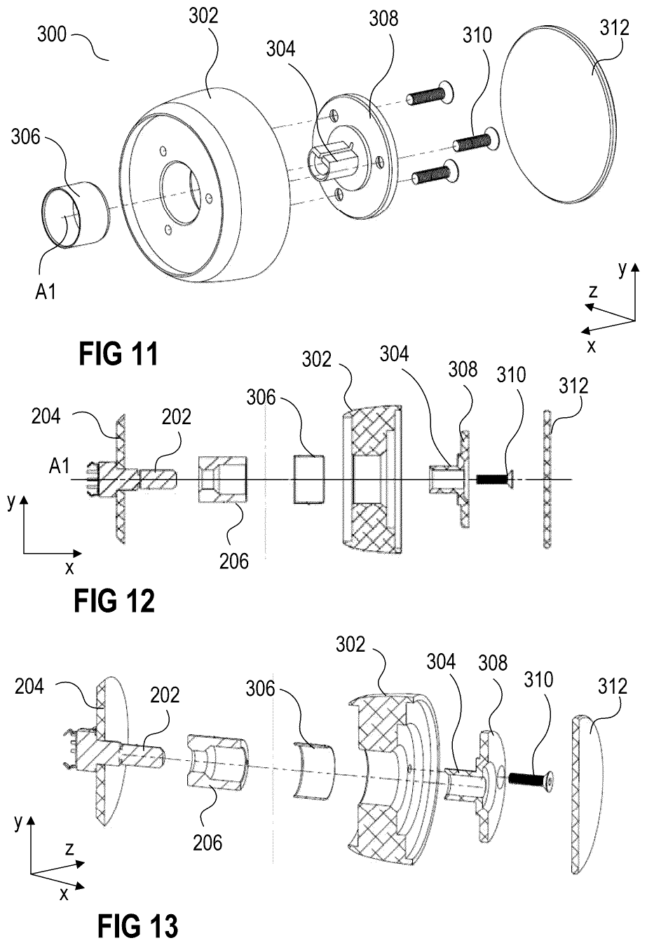

The driver element 304, according to one example, may be integrally formed with the outer knob element 302. Now referring to the exploded three-dimensional view of FIG. 11, the knob assembly 300 alternatively may further comprise a panel element 308 arranged to cover the second side of the bush 306, wherein the second side of the bush 306 is a side facing away from the encoder assembly 200 in the fully assembled state. The driver element 304 may extend from the panel element 308 and into the bush 306. As is schematically illustrated in FIG. 11, the panel element 308 may be attached to the outer knob element 302 by, for example, one or more screws 310. According to one example, the driver element 304 and the panel element 308 are formed monolithically as a single piece. It is, however, also possible that the driver element 304 be attached to a panel element 308 in any other suitable way, for example, such as gluing, screwing, etc. In order to conceal the panel element 308 and/or any other components arranged inside the outer knob element 302 (e.g., screws 310), the knob assembly 300 may further comprise a cover 312 arranged to conceal the panel element 308 and/or any other components arranged inside the outer knob element 302.

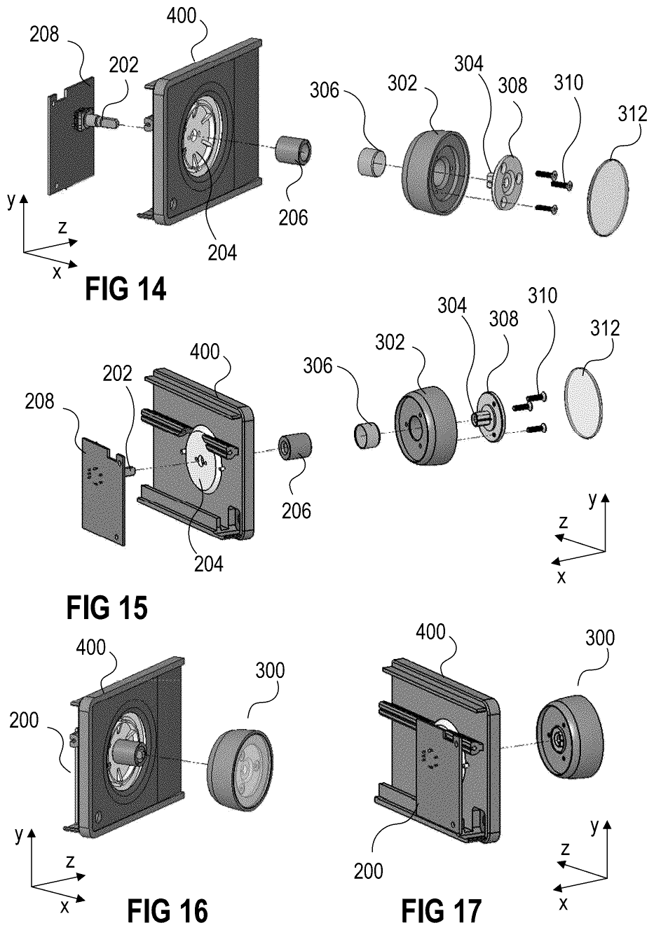

Now referring to FIG. 12, an exploded cross-sectional view of a control knob according to further embodiments of the disclosure is schematically illustrated. FIG. 13 schematically illustrates a three-dimensional exploded cross-sectional view of the control knob 100 of FIG. 12. FIG. 14 schematically illustrates an exploded three-dimensional view of a control knob according to further embodiments of the disclosure. FIG. 15 schematically illustrates the exploded three-dimensional view of the control knob of FIG. 14 from a different perspective. FIG. 16 schematically illustrates the control knob of FIG. 14 in a partly assembled state from a first perspective (front side). FIG. 17 schematically illustrates the control knob of FIG. 15 in a partly assembled state. That is, FIG. 17 schematically illustrates the partly assembled control knob 100 of FIG. 16 from a different perspective (back side). As can be seen in FIGS. 14 to 17, the control knob 100 may further comprise a circuit board 208, wherein the base element of the shaft encoder 202 is coupled to the circuit board 208. For example, the circuit board 208 may carry electrical circuitry and components which are required to convert rotary and axial input movement of the knob assembly 300 into electronic signals. FIGS. 14 to 17 further schematically illustrate a panel or aperture 400. The panel or aperture 400 may carry the fascia panel 204 and may conceal the components of the encoder assembly 200. In one example, the panel or aperture 400 may be part of a casing of a media device.

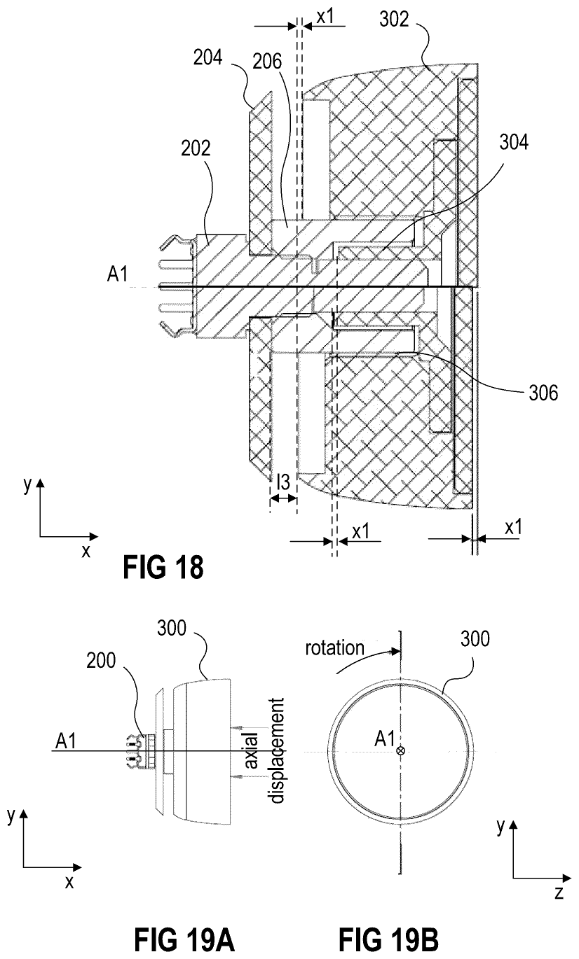

As has been described in detail above, the control knob 100 is configured to convert rotary input movement into electronic signals. The control knob 100, however, may also be configured to convert axial input movement into electronic signals. The shaft encoder 202 may comprise a push switch (not specifically illustrated). The push switch may close when the knob assembly 300 moves axially along the rotation axis A1 towards the encoder assembly 200, and may open when, subsequently, the knob assembly 300 moves axially along the rotation axis A1 away from the encoder assembly 200. Encoder switches 202 providing such a function are generally known. FIG. 18 schematically illustrates an axial movement of the knob assembly 300. In particular, in an upper part of FIG. 18 (above rotation axis A1), the knob assembly 300 is illustrated in its normal position (e.g., push switch open). In a lower part of FIG. 18 (below rotation axis A1), the knob assembly 300 is illustrated in a pushed-in position (e.g., push switch closed). That is, a user may push the outer knob element 302 towards the encoder assembly 200. All parts that are firmly attached to the outer knob element 302 such as, for example, the bush 304, and the driver element 304, are pushed towards the encoder assembly 200 together with the outer knob element 302. The outer knob element 302 may be slightly displaced out of its normal position (e.g., x1<3 mm, or x1<1 mm, dependent on the operation of the particular encoder used) and may then return to its normal position.

As the shaft of the shaft encoder 202 is tightly connected to the driver element 304, the shaft will also axially move together with the outer knob element 302. The shaft may not only be rotationally but also axially movable with respect to the base element. That is, the shaft may be moved in a direction towards the base element. The push switch may be located in the base element and may be activated (e.g., closed), when the shaft moves towards the base element along the rotation axis A1. As can be seen, the control knob may allow for an axial displacement of the knob assembly 300 with respect to the encoder assembly 200. For example, a distance 13 between the outer knob element 302 and a fascia panel 204 may be larger than or at least equal to a maximum displacement x1 of the knob assembly 300 towards the fascia panel 204. Even further, the inner volume defined by the bearing collar 206 may be large enough to allow for an axial movement of the driver element 304. The bearing collar 206, at an interface between the first section and the second section (see FIG. 5), may provide an end stop for the driver element 304 in order to limit the axial displacement of the knob assembly 300.

FIG. 19A schematically illustrates a side view of an exemplary control knob to visualize an axial displacement of the knob assembly 300 with respect to the encoder assembly 200. FIG. 19B schematically illustrates a front view of an exemplary control knob to visualize a rotational movement of the knob assembly 300 around the rotation axis A1.

The knob assembly 300 of a control knob 100 as described above is rigidly supported on the encoder assembly. This results in a high-quality feel for a user when operating the knob assembly 300, i.e. the outer knob element 302. Further, the shaft encoder 202 may be operated consistently and evenly by the arrangements as have been described above. That is, the knob assembly 300 may be smoothly moved. Rotary and axial movement of the outer knob element 302 operates the shaft encoder 202 consistently and evenly. The arrangements disclosed herein allow for only minimal play or minimal clearance between the knob assembly 300 and the encoder assembly 200, in particular between the bush 306 and the bearing collar 206, due to the close fit of the knob assembly 300 on the bearing collar 206 which eliminates a feeling of “looseness”. This reduces the slack or play. The knob assembly 300 is rigidly supported on the encoder assembly 200 to eliminate any “wobble” which results in a high-quality feel for a user of the control knob 100.

It may be understood, that the systems as illustrated above are merely examples. While various embodiments of the invention have been described, it will be apparent to those of ordinary skill in the art that many more embodiments and implementations are possible within the scope of the invention. In particular, the skilled person will recognize the interchangeability of various features from different embodiments. Although these techniques and systems have been disclosed in the context of certain embodiments and examples, it will be understood that these techniques and systems may be extended beyond the specifically disclosed embodiments to other embodiments and/or uses and obvious modifications thereof. Accordingly, the invention is not to be restricted except in light of the attached claims and their equivalents.

The description of embodiments has been presented for purposes of illustration and description. Suitable modifications and variations to the embodiments may be performed in light of the above description or may be acquired from practicing the methods. The described arrangements are exemplary in nature, and may include additional elements and/or omit elements. As used in this application, an element recited in the singular and proceeded with the word “a” or “an” should be understood as not excluding plural of said elements, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects. The described systems are exemplary in nature and may include additional elements and/or omit elements. The subject matter of the present disclosure includes all novel and non-obvious combinations and sub-combinations of the various systems and configurations, and other features, functions, and/or properties disclosed. The following claims particularly point out subject matter from the above disclosure that is regarded as novel and non-obvious.

What is claimed is:

1. A control knob comprising an encoder assembly configured to convert rotary and axial input movement into electronic signals, and a knob assembly attached to the encoder assembly and configured to be operated by a user, wherein
the encoder assembly comprises a shaft encoder having a shaft that is configured to be rotated around a rotation axis and to be moved axially along the rotation axis,
the knob assembly comprises an outer knob element configured to be operated by a user,
the knob assembly further comprises a bush defining a cylindrical cavity inside the outer knob element, wherein the bush has an opening towards a first side of the outer knob element facing towards the encoder assembly,
the knob assembly further comprises a driver element extending into the bush from a second side opposite the first side, and enclosing the shaft of the shaft encoder to transfer a movement of the outer knob element to the shaft encoder,
the encoder assembly further comprises a cylindrical bearing collar, the cylindrical bearing collar defining an inner volume that is open towards a first side and towards a second side opposite the first side, wherein the shaft encoder from the first side extends into the inner volume of the cylindrical bearing collar towards the second side, and
the driver element extends into the inner volume of the cylindrical bearing collar from the second side towards the first side, and between the shaft of the shaft encoder and the cylindrical bearing collar.

2. The control knob of claim 1, wherein
the bush has a smooth inner surface facing towards the cylindrical cavity,
the cylindrical bearing collar has a smooth outer surface facing away from the shaft encoder arranged inside the inner volume defined by the cylindrical bearing collar,
an inner diameter of the bush corresponds to or is up to 0.5 mm larger than an outer diameter of the cylindrical bearing collar, and
when the outer knob element is operated by a user, the smooth inner surface of the bush smoothly glides along the smooth outer surface of the cylindrical bearing collar.

3. The control knob of claim 1, wherein the shaft encoder further comprises a base element, wherein the shaft of the shaft encoder is movable with respect to the base element.

4. The control knob of claim 3 further comprising a fascia panel, the fascia panel having a first main surface and a second main surface opposite the first main surface, and a hole extending through the fascia panel from the first to the second main surface, wherein
the shaft encoder extends through the hole in the fascia panel such that the base element is at least partly arranged on a first side of the fascia panel and the shaft of the shaft encoder is arranged on a second side of the fascia panel.

5. The control knob of claim 3 further comprising a circuit board, wherein the base element of the shaft encoder is coupled to the circuit board.

6. The control knob of claim 1, wherein the knob assembly comprises a panel element arranged to cover the second side of the bush, wherein the driver element extends from the panel element into the bush.

7. The control knob of claim 6, wherein the panel element is attached to the outer knob element by one or more screws.

8. The control knob of claim 6 further comprising a cover attached to the outer knob element and arranged to conceal the panel element.

9. The control knob of claim 6, wherein the driver element and the panel element are formed monolithically.

10. The control knob of claim 1, wherein the shaft encoder comprises a push switch, wherein the push switch closes when the knob assembly moves axially along the rotation axis towards the encoder assembly, and opens when, subsequently, the knob assembly moves axially along the rotation axis away from the encoder assembly.

11. The control knob of claim 1, wherein the cylindrical bearing collar comprises a first section defining a cylindrical inner volume, and a second section comprising a thread, and wherein the cylindrical bearing collar is screwed on the shaft encoder.

12. The control knob of claim 11, wherein the second section of the cylindrical bearing collar provides an end stop for the driver element in order to limit an axial displacement of the knob assembly.

13. A control knob comprising:
an encoder assembly configured to convert rotary and axial input movement into electronic signals, and
a knob assembly attached to the encoder assembly and including an outer knob element configured to be operated by a user, wherein:
the encoder assembly comprises a shaft encoder having a shaft that is configured to be rotated around a rotation axis and to be moved axially along the rotation axis,
the knob assembly further comprises a bush defining a cylindrical cavity inside the outer knob element, wherein the bush has an opening towards a first side of the outer knob element facing towards the encoder assembly,
the knob assembly further comprises a driver element extending into the bush from a second side opposite the first side, and enclosing the shaft of the shaft encoder to transfer a movement of the outer knob element to the shaft encoder,
the encoder assembly further comprises a cylindrical bearing collar, the cylindrical bearing collar defining an inner volume that is open towards a first side and towards a second side opposite the first side, wherein the shaft encoder from the first side extends into the inner volume of the cylindrical bearing collar towards the second side, and
the driver element extends into the inner volume of the cylindrical bearing collar from the second side towards the first side, and between the shaft of the shaft encoder and the cylindrical bearing collar.

14. The control knob of claim 13, wherein
the bush has a smooth inner surface facing towards the cylindrical cavity,
the cylindrical bearing collar has a smooth outer surface facing away from the shaft encoder arranged inside the inner volume defined by the cylindrical bearing collar,
an inner diameter of the bush corresponds to or is up to 0.5 mm larger than an outer diameter of the cylindrical bearing collar, and
when the outer knob element is operated by a user, the smooth inner surface of the bush smoothly glides along the smooth outer surface of the cylindrical bearing collar.

15. The control knob of claim 13, wherein the shaft encoder further comprises a base element, wherein the shaft of the shaft encoder is movable with respect to the base element.

16. The control knob of claim 15 further comprising a fascia panel, the fascia panel having a first main surface and a second main surface opposite the first main surface, and a hole extending through the fascia panel from the first to the second main surface, wherein
the shaft encoder extends through the hole in the fascia panel such that the base element is at least partly arranged on a first side of the fascia panel and the shaft of the shaft encoder is arranged on a second side of the fascia panel.

17. The control knob of claim 15 further comprising a circuit board, wherein the base element of the shaft encoder is coupled to the circuit board.

18. The control knob of claim 13, wherein the knob assembly comprises a panel element arranged to cover the second side of the bush, wherein the driver element extends from the panel element into the bush.

19. The control knob of claim 18, wherein the panel element is attached to the outer knob element by one or more screws.

20. A control knob comprising:
an encoder assembly configured to convert rotary and axial input movement into electronic signals, and
a knob assembly attached to the encoder assembly and including an outer knob element configured to be operated by a user, wherein:
the encoder assembly comprises a shaft encoder having a shaft that is configured to be rotated around a rotation axis and to be moved axially along the rotation axis,
the knob assembly further comprises a bush defining a cavity inside the outer knob element, wherein the bush has an opening towards a first side of the outer knob element facing towards the encoder assembly,
the knob assembly further comprises a driver element extending into the bush from a second side opposite the first side, and enclosing the shaft of the shaft encoder to transfer a movement of the outer knob element to the shaft encoder,
the encoder assembly further comprises a bearing collar, the bearing collar defining an inner volume that is open towards a first side and towards a second side opposite the first side, wherein the shaft encoder from the first side extends into the inner volume of the bearing collar towards the second side, and
the driver element extends into the inner volume of the bearing collar from the second side towards the first side, and between the shaft of the shaft encoder and the bearing collar.
